(19) United States
(12) Patent Application Publication
(10) Pub. No.: US 2021/0218953 A1
(43) Pub. Date: Jul. 15, 2021

(54) INFINITELY ADJUSTABLE ACTIVE DIGITAL TELEVISION (DTV) AMPLIFIER WITH TIMING AND DISPLAYING FUNCTIONS

(71) Applicant: Jiangxi Innovation Technology Co., Ltd., Ji'an City (CN)

(72) Inventors: Xiaobing LIU, Ji 'An City (CN); Qin LI, Ganzhou City (CN)

(21) Appl. No.: 16/967,076

(22) PCT Filed: Dec. 30, 2019
(86) PCT No.: PCT/CN2019/129721

§ 371 Date: Aug. 3, 2020

(30) Foreign Application Priority Data
Sep. 19, 2019 (CN) 201910885544.3

(51) Int. Cl. H04N 17/00; H04N 5/14; H04N 7/10

(52) U.S. Cl. CPC H04N 17/004; H04N 7/102; H04N 5/148

(57) ABSTRACT

An infinitely adjustable active digital television (DTV) amplifier with timing and displaying functions is connected between an antenna and a coaxial cable for detecting, adjusting, and displaying an amplification factor of the amplifier. The amplifier includes: a LNA amplifier unit having a source connected to a DC source, a RF input end connected to the antenna and a RF output end connected to the coaxial cable; an infinite adjustment unit connected to a DC potentiometer which has an output terminal connected to the source of the LNA amplifier unit for providing bias voltage; and a gain detection and a display unit having a control chip, a display driving circuit and a display screen. The control chip is connected to the infinite adjustment unit for collecting instantaneous voltage, and displaying an amplification factor corresponding to the instantaneous voltage on a display screen.

### FIELD OF THE INVENTION

The present invention relates to the technical field of digital televisions, and more particularly to an infinitely adjustable active digital television (DTV) amplifier with timing and displaying functions.

### BACKGROUND OF THE INVENTION

In the operating principle of a conventional active DTV antenna, an antenna vibrator is provided for receiving weak electromagnetic waves (including useful signals and interference signal) in the air, and sending the electromagnetic waves to a low noise amplifier (LNA) through a coaxial cable to perform a basic signal amplification. The amplification factor of the conventional active DTV antenna is fixed, so that the best signal amplification effect cannot be achieved and the signal amplification cannot be felt intuitively. Therefore, a display is usually added to allow users to see the signal amplification more intuitively.

### SUMMARY OF THE INVENTION

In view of the aforementioned drawbacks of the conventional signal amplifier, the present invention provides an infinitely adjustable active digital television (DTV) amplifier with timing and displaying functions to overcome the drawbacks of the prior art.

Therefore, it is a primary objective of the present invention to adjust the amplification factor of an amplifier and detect and display the amplification factor of the amplifier.

To achieve the aforementioned and other objectives, the present invention discloses an infinitely adjustable active digital television (DTV) amplifier with timing and displaying functions, which is coupled between an antenna and a coaxial cable and comprises: a LNA amplifier unit, an infinite adjustment unit, and a gain detection and display unit, and the LNA amplifier unit has a source, a RF input end and a RF output end, the source is coupled to a DC source, the RF input end is coupled to the antenna, and the RF output end is coupled to the coaxial cable; the infinite adjustment unit is coupled to a DC potentiometer, and the potentiometer has an output terminal coupled to the source of the LNA amplifier unit for providing bias voltage; and the gain detection and display unit comprises a control chip, a display driving circuit and a display screen, and the control chip is coupled to the infinite adjustment unit for collecting an instantaneous voltage and displaying an amplification factor corresponding to the instantaneous voltage on a display screen.

In one or more embodiments of the present invention, the RF input end has a capacitor C9 serially coupled thereto, and the RF output end has capacitors C6 and C7 serially coupled thereto, and the capacitors C6 and C7 have a connection point grounded through a resistor R6.

In one or more embodiments of the present invention, the LNA amplifier unit comprises a BAV99 device and a triode U, and the BAV99 device has a plurality of pins 1 and 2 grounded, and a pin 3 coupled to the RF input end, and the triode U has a base coupled to the RF output end, an emitter grounded, and a collector coupled to the RF output end; and the resistors R9, R8 are serially coupled between the source and the base of the triode U, and the capacitor C8 and the resistor R5 are serially coupled to each other and then parallelly coupled to the resistor R8.

In one or more embodiments of the present invention, the source of the LNA amplifier unit is coupled to the DC source through an inductor L1, and grounded through a capacitor C12.

In one or more embodiments of the present invention, the RF input end and the source are coupled to an ESD device separately.

In one or more embodiments of the present invention, the LNA amplifier unit is a microwave bandpass amplifier chip with a model number of a BPF420 series.

In one or more embodiments of the present invention, the control chip is integrated with a timer.

In one or more embodiments of the present invention, the infinite adjustment unit comprises a plurality of resistors R1, R2, RX1, RX2 and R10, and a capacitor C11; the resistors R1 and RX1 are serially coupled to each other, and the resistor R2 and RX2 are serially coupled to each other, and both of the resistors R1 and R2 are coupled to the DC source, and both of the resistors RX1 and RX2 are grounded through a resistor R10, and the capacitor C11 is parallelly coupled to both terminals of the resistor R10, and the resistor RX1 has an adjustment pin coupled to the gain detection and display unit, and the adjustment pin of the resistor RX2 is used as an output terminal of the infinite adjustment unit.

The present invention has the following advantageous effects: The design with the infinitely adjustable circuit for adjusting and amplifying the gain and gain detection and display circuit for enhancing the practicality of the amplifier is applicable for various types of antennas to provide and makes the applications more convenient. In addition, the input side and output side of the LNA amplifier unit are designed specifically for the impedance matching and bandpass filter circuits of 4G and related frequencies to overcome the problems of the conventional DTV antenna that cannot identify and filter interference signals, and thus resulting in a strong interference source after the signal amplification, and failing to lock the receiving frequency range of the antenna, identify, attenuate and filter the interference signals to enhance the antenna gain, or avoid a serious interference to the reception of 4G signals and microwave communication of adjacent frequencies.

### BRIEF DESCRIPTION OF THE DRAWINGS

FIG. 1 is a schematic circuit diagram of a LNA amplifier unit of the present invention;

FIG. 2 is a schematic circuit diagram of an infinite adjustment unit of the present invention;

FIG. 3 is a schematic circuit diagram of a control chip of the present invention;

FIG. 4 is a schematic circuit diagram of a display driving circuit of the present invention; and

FIG. 5 is a schematic circuit diagram of a display screen of the present invention.

### DESCRIPTION OF THE PREFERRED EMBODIMENTS

The objectives, technical characteristics and effects of the present invention will become apparent with the detailed description of preferred embodiments accompanied with the illustration of related drawings. It is intended that the embodiments and drawings disclosed herein are to be considered illustrative rather than restrictive.

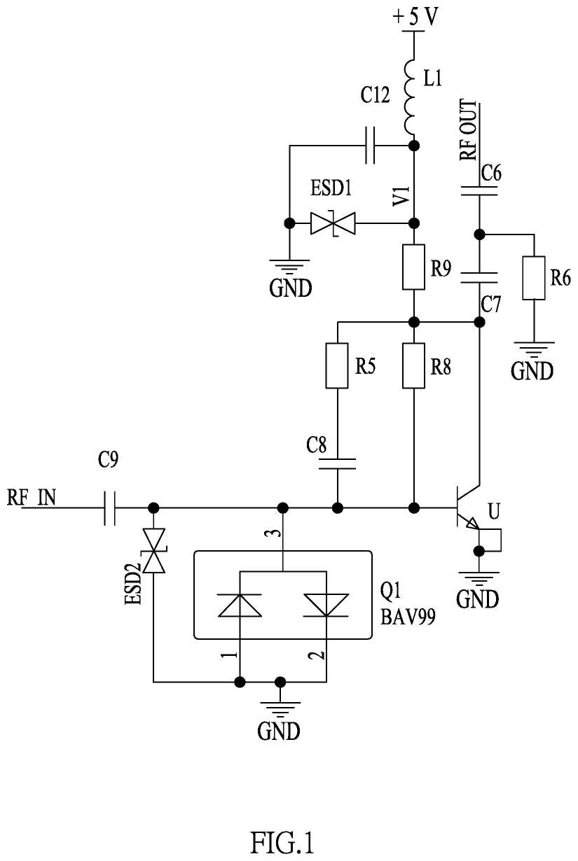

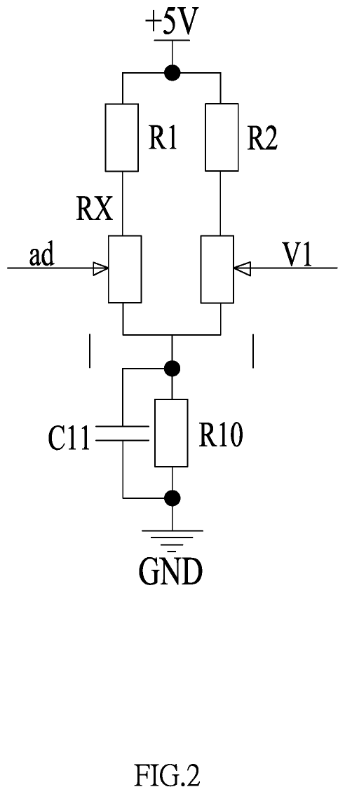

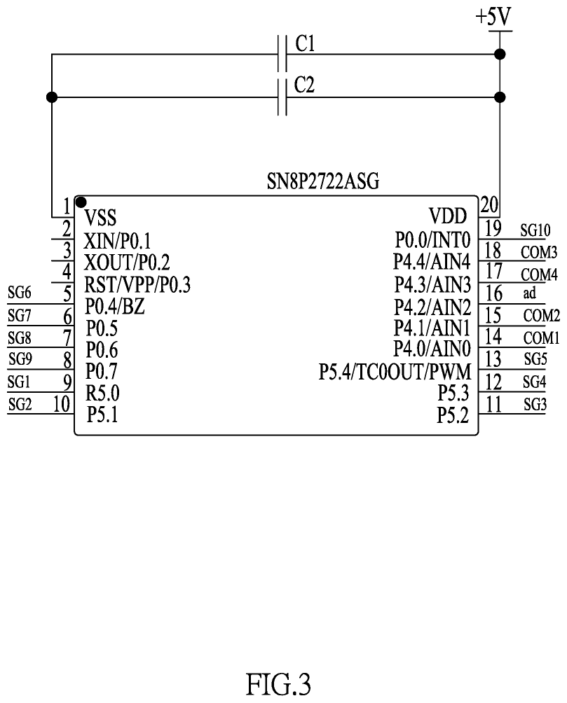

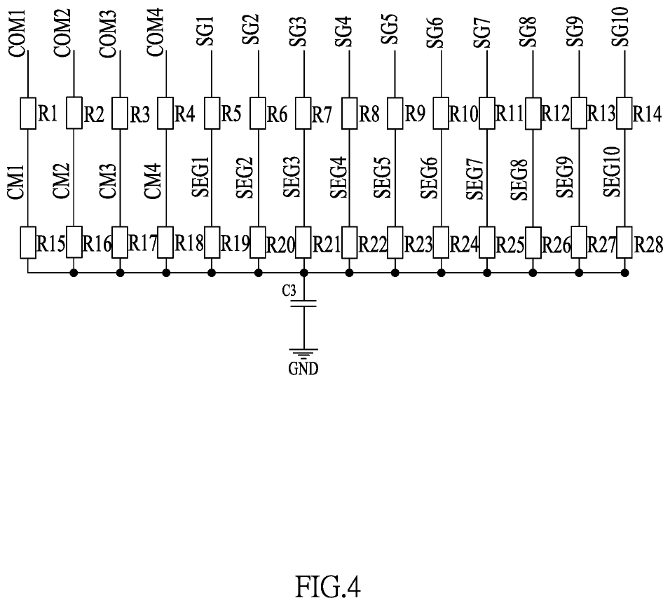

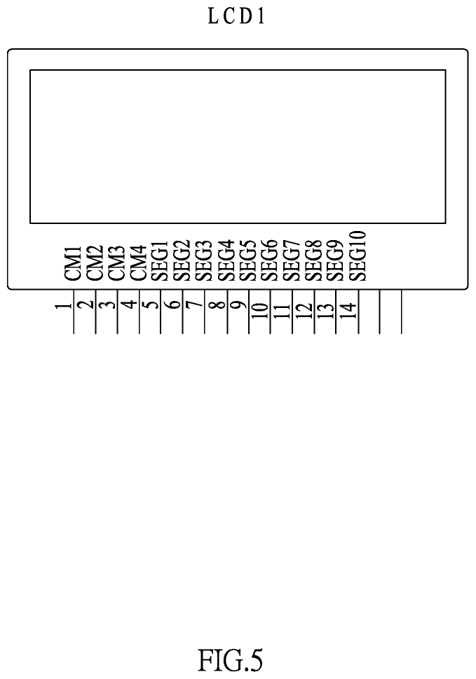

With reference to FIGS. 1 to 5 for an infinitely adjustable active digital television (DTV) amplifier with timing and displaying functions of the present invention, the infinitely adjustable active digital television (DTV) amplifier is coupled between an antenna and a coaxial cable and comprises a LNA amplifier unit, an infinite adjustment unit, and a gain detection and display unit, characterized in that the LNA amplifier unit has a source, a RF input end and a RF output end, the source is coupled to a DC source, the RF input end is coupled to the antenna, and the RF output end is coupled to the coaxial cable; the infinite adjustment unit is coupled to a DC potentiometer, and the potentiometer has an output terminal coupled to the source of the LNA amplifier unit for providing bias voltage; and the gain detection and display unit comprises a control chip, a display driving circuit and a display screen, and the control chip is coupled to the infinite adjustment unit for collecting an instantaneous voltage and displaying an amplification factor corresponding to the instantaneous voltage on a display screen.

Specifically, the RF input end has a capacitor C9 serially coupled thereto, and the RF output end has capacitors C6 and C7 serially coupled thereto, and the capacitors C6 and C7 have a connection point grounded through a resistor R6. By this design, the impedance matching and bandpass filter of the RF input end and the output terminal can be achieved. The LNA amplifier unit comprises a BAV99 device and a triode U, and the BAV99 device has a plurality of pins 1 and 2 grounded, and a pin 3 coupled to the RF input end, and the triode U has a base coupled to the RF output end, an emitter grounded, and a collector coupled to the RF output end; and the resistors R9, R8 are serially coupled between the source and the base of the triode U, and the capacitor C8 and the resistor R5 are serially coupled to each other and then parallelly coupled to the resistor R8. The source of the LNA amplifier unit is coupled to the DC source through an inductor L1, and grounded through a capacitor C12. The RF input end is coupled to an electrostatic discharge device ESD2, and the source is coupled to an electrostatic discharge device ESD1. The infinite adjustment unit comprises a plurality of resistors R1, R2, RX1, RX2 and R10, and a capacitor C11; the resistors R1 and RX1 are serially coupled to each other, and the resistor R2 and RX2 are serially coupled to each other, and both of the resistors R1 and R2 are coupled to the DC source, and both of the resistors RX1 and RX2 are grounded through a resistor R10, and the capacitor C11 is parallelly coupled to both terminals of the resistor R10, wherein the resistor RX1 has an adjustment pin coupled to the gain detection and display unit, and the adjustment pin of the resistor RX2 is coupled to a connection point of an inductor L1 and a resistor R9.

Preferably, the LNA amplifier unit is a microwave bandpass amplifier chip with the model number of a BPF420 series, and the control chip is one with the model number of a SN8P2722 series. The control chip is integrated with a timer which is used for counting and recording the operating time of the DTV antenna.

While the invention has been described by means of specific embodiments, numerous modifications and variations could be made thereto by those skilled in the art without departing from the scope and spirit of the invention as set forth in the claims.

1. An infinitely adjustable active digital television (DTV) amplifier with timing and displaying functions, coupled between an antenna and a coaxial cable, comprising: a LNA amplifier unit, an infinite adjustment unit, and a gain detection and display unit, characterized in that the LNA amplifier unit has a source, a RF input end and a RF output end, the source is coupled to a DC source, the RF input end is coupled to the antenna, and the RF output end is coupled to the coaxial cable; the infinite adjustment unit is coupled to a DC potentiometer, and the potentiometer has an output terminal coupled to the source of the LNA amplifier unit for providing bias voltage; and the gain detection and display unit comprises a control chip, a display driving circuit and a display screen, and the control chip is coupled to the infinite adjustment unit for collecting an instantaneous voltage and displaying an amplification factor corresponding to the instantaneous voltage on a display screen.

2. The infinitely adjustable active digital television (DTV) amplifier with timing and displaying functions as claim in claim 1, wherein the RF input end has a capacitor C9 serially coupled thereto, and the RF output end has capacitors C6 and C7 serially coupled thereto, and the capacitors C6 and C7 have a connection point grounded through a resistor R6.

3. The infinitely adjustable active digital television (DTV) amplifier with timing and displaying functions as claim in claim 1, wherein the LNA amplifier unit comprises a BAV99 device and a triode U, and the BAV99 device has a plurality of pins 1 and 2 grounded, and a pin 3 coupled to the RF input end, and the triode U has a base coupled to the RF output end, an emitter grounded, and a collector coupled to the RF output end; and the resistors R9, R8 are serially coupled between the source and the base of the triode U, and the capacitor C8 and the resistor R5 are serially coupled to each other and then parallelly coupled to the resistor R8.

4. The infinitely adjustable active digital television (DTV) amplifier with timing and displaying functions as claim in claim 3, wherein the source of the LNA amplifier unit is coupled to the DC source through an inductor L1, and grounded through a capacitor C12.

5. The infinitely adjustable active digital television (DTV) amplifier with timing and displaying functions as claim in claim 4, wherein the RF input end and the source are coupled to an ESD device separately.

6. The infinitely adjustable active digital television (DTV) amplifier with timing and displaying functions as claim in claim 1, wherein the LNA amplifier unit is a microwave bandpass amplifier chip with a model number of a BPF420 series.

7. The infinitely adjustable active digital television (DTV) amplifier with timing and displaying functions as claim in claim 1, wherein the control chip is integrated with a timer.

8. The infinitely adjustable active digital television (DTV) amplifier with timing and displaying functions as claim in claim 1, wherein the infinite adjustment unit comprises a plurality of resistors R1, R2, RX1, RX2 and R10, and a capacitor C11; the resistors R1 and RX1 are serially coupled to each other, and the resistor R2 and RX2 are serially coupled to each other, and both of the resistors R1 and R2 are coupled to the DC source, and both of the resistors RX1 and RX2 are grounded through a resistor R10, and the capacitor C11 is parallelly coupled to both terminals of the resistor R10, and the resistor RX1 has an adjustment pin coupled to the gain detection and display unit, and the adjustment pin of the resistor RX2 is used as an output terminal of the infinite adjustment unit.
